(19) United States
(12) Patent Application Publication
(10) Pub. No.: US 2014/0044625 A1
(43) Pub. Date: Feb. 13, 2014

(54) HYDROCARBON TRAP HAVING IMPROVED ADSORPTION CAPACITY

(71) Applicants: Jason Aaron Lupescu, Ypsilanti, MI (US); Hungwen Jen, Troy, MI (US); Jeffrey Scott Hepburn, Birmingham, MI (US)

(72) Inventors: Jason Aaron Lupescu, Ypsilanti, MI (US); Hungwen Jen, Troy, MI (US); Jeffrey Scott Hepburn, Birmingham, MI (US)

(73) Assignee: FORD GLOBAL TECHNOLOGIES, LLC, Dearborn, MI (US)

(21) Appl. No.: 13/569,472

(22) Filed: Aug. 8, 2012

(51) Int. Cl. B01J 29/06; B01D 53/94; B01J 29/068; B01J 29/40; B01J 29/70

(52) U.S. Cl. 423/212; 502/60; 502/77; 502/64; 502/73; 502/74; 422/180

(57) ABSTRACT

A hydrocarbon trap is provided for reducing cold-start hydrocarbon emissions. The trap is formed by extruding from about 60 to 80% by weight zeolite and from about 20 to 40% by weight of a binder to form an extruded zeolite monolith. A three-way catalyst and an oxygen storage capacity material may also be included in the trap. The hydrocarbon trap contains from about 5.0 to 8.0 g/in.³ zeolite, which provides increased hydrocarbon retention. The hydrocarbon trap may be positioned in the exhaust gas passage of a vehicle such that hydrocarbons are adsorbed on the trap and stored until the monolith reaches a sufficient temperature for catalyst activation.

### BACKGROUND OF THE INVENTION

Embodiments described herein relate to a hydrocarbon trap having improved adsorption of cold-start engine emissions, and more particularly, to a hydrocarbon trap comprising an extruded zeolite monolith substrate for improving adsorption and retention of hydrocarbons.

In recent years, considerable efforts have been made to reduce the level of hydrocarbon (HC) emissions from vehicle engines. Conventional exhaust treatment catalysts such as three-way catalysts achieve conversion of hydrocarbons to water and help prevent the exit of unburnt or partially burnt hydrocarbon emissions from a vehicle. However, hydrocarbon emissions are high during cold starting of the engine before the latent heat of the exhaust gas allows the catalyst to become active, i.e., before the catalyst has reached its “light-off” temperature.

Hydrocarbon traps have been developed for reducing emissions during cold-start by trapping/adsorbing hydrocarbon (HC) emissions at low temperatures and releasing/desorbing them from the trap at sufficiently elevated temperatures for oxidation over a catalyst, such as a three-way catalyst. Currently, zeolites have been the most widely used adsorption materials for hydrocarbon traps. The zeolites are typically combined with a three-way catalyst in the form of a washcoat which is supported on a monolith substrate.

While increasing the zeolite washcoat loading typically provides improved conversion efficiency, there is a limit to how much the total washcoat loading can be increased without experiencing an undesirable increase in backpressure in the HC trap and decreased conversion.

It would be desirable to improve the overall HC trap function by maximizing adsorption capacity during cold start and minimizing the desorption rate until the catalyst has reached its “light off” temperature.

### SUMMARY OF THE INVENTION

Embodiments of the invention provide a hydrocarbon trap which utilizes an extruded zeolite monolith and which includes a three-way catalyst to store and convert hydrocarbon emissions. By utilizing an extruded zeolite monolith, the zeolite loading is increased and delays hydrocarbon desorption until higher temperatures are reached, resulting in improved conversion efficiency with the use of the three-way catalyst material.

According to one aspect of the invention, a hydrocarbon trap for reducing cold-start vehicle exhaust emissions is provided and comprises an extruded monolithic substrate formed from a hydrocarbon trapping material comprising from about 60 to 80% by weight zeolite, from 20 to 40% by weight of a binder; and a three-way catalyst.

The extruded monolithic substrate preferably has a honeycomb structure with a wall thickness of about 10 to 20 mils and a cell density of about 200 to 400 cells/in.² (cpsi).

The zeolite preferably has a Si/Al₂ ratio of from about 20 to about 40. The zeolite may comprise ion-exchanged, framework substituted, or unexchanged zeolite, and may be selected from beta-zeolite, ZSM-5 zeolite, or mixtures thereof. By “unexchanged,” it is meant that no cations have been exchanged or substituted into the zeolite structure. The zeolite may be selected from zeolites with a pore diameter of about 4 to 8 Å that have a network of parallel straight or wavy channels (not cage networks) in one or more axis directions and possess Bronsted acid sites that are stable against steaming at temperatures up to 700° C.

Preferably, the zeolite comprises beta zeolite. The hydrocarbon trap preferably has a zeolite loading of from about 5.0 to about 8.0 g/in.³

The binder is preferably selected from alumina, ceria, zirconia, or ceria-zirconia, composite binder refractory fibers, or mixtures thereof.

In one embodiment, the three-way catalyst comprises a precious metal selected from platinum, palladium, rhodium, and mixtures thereof.

The hydrocarbon trap may further include an oxygen storage capacity (OSC) material to provide additional oxygen needed for the oxidation of hydrocarbons. The oxygen storage capacity material may be selected from ceria-zirconia, ceria-praesodymium, or mixtures thereof.

According to another aspect of the invention, a method of forming a hydrocarbon trap for use in an exhaust treatment system is provided in which a slurry of a hydrocarbon trapping material comprising from about 60 to 80% by weight zeolite, from about 20 to 40% by weight of a binder; a three-way catalyst, and optionally, an oxygen storage capacity material, is extruded through an extrusion die to form a monolithic substrate. In one embodiment, the extrusion die is configured so as to provide a monolithic substrate having an open frontal area of between about 40 and 60%. By “open frontal area”, or OFA, it is meant the part of the total substrate cross-sectional area which is available for the flow of gas. The OFA is expressed as a percentage of the total substrate cross-section or substrate void fraction.

In an alternative embodiment of the method, the three-way catalyst is washcoated on the extruded monolithic substrate or is impregnated into the substrate after extrusion. The OSC material may also be washcoated on the substrate with the three-way catalyst or may be impregnated with the three-way catalyst into the substrate after extrusion.

According to another aspect of the invention, an exhaust treatment system is provided which comprises a hydrocarbon trap positioned in the exhaust passage of a vehicle for reducing cold-start vehicle exhaust emissions which comprises an extruded monolithic substrate formed from a hydrocarbon trapping material comprising from about 60 to 80% by weight zeolite, from about 20 to 40% by weight of a binder; a three-way catalyst, and optionally, an oxygen storage capacity material.

As exhaust gases are passed through the exhaust passage, the hydrocarbon trap provides improved adsorption of unburned hydrocarbon emissions and retains the hydrocarbons until the exhaust gases heat the trap to a sufficient temperature for catalytic conversion, i.e., about 200° C. to 400° C., at which trine the hydrocarbons are desorbed and are oxidized by the three-way catalyst. Preferably, a trap (having about 30,000/hr gas space velocity) adsorbs and retains from about 50 to 90 wt. % of the total non-methane hydrocarbons in the exhaust gas at temperatures up to about 200° C.

Accordingly, it is a feature of embodiments of the invention to provide a hydrocarbon trap for reducing cold start vehicle exhaust emissions. Other features and advantages of the invention will be apparent from the following description, the accompanying drawings, and the appended claims.

### BRIEF DESCRIPTION OF THE DRAWINGS

FIG. 1 is a schematic illustration of a hydrocarbon trap in accordance with an embodiment of the invention;

FIG. 2A is an enlarged view of one cell of the hydrocarbon trap of FIG. 1;

FIG. 2B is a cross-sectional view of an extruded zeolite monolith including a washcoat thereon;

FIG. 3 is a schematic illustration of an exhaust treatment system including a hydrocarbon trap in accordance with an embodiment of the invention;

FIG. 4 is a graph illustrating the hydrocarbon retention obtained with the hydrocarbon trap comprising the extruded zeolite monolith in comparison with a trap comprising a washcoated zeolite monolith; and

FIG. 5 is a graph illustrating the hydrocarbon desorption of a hydrocarbon trap comprising the extruded zeolite monolith in comparison with a washcoated zeolite monolith; and

FIG. 6 is a graph illustrating the hydrocarbon oxidation performance of washcoated and extruded zeolite monoliths.

### DETAILED DESCRIPTION OF THE PREFERRED EMBODIMENTS

Embodiments of the hydrocarbon trap described herein utilize a zeolite which is extruded to form a monolithic substrate for the storage and conversion of hydrocarbon emissions. The trap may also include an oxygen storage capacity material (OSC) and a three-way catalyst. The hydrocarbon trap utilizing an extruded zeolite monolith differs from prior zeolite washcoated ceramic monoliths which include an additional washcoated layer of a precious metal catalyst. The use of an extruded zeolite monolith effectively replaces unutilized ceramic support material with useful rigid adsorbant material (zeolite). The extruded zeolite monolith also allows a higher effective loading of zeolite into the substrate, i.e., more zeolite capacity per unit volume is achieved.

This is an improvement over the use of prior zeolite washcoated cordierite monoliths, which suffer from the problem of increased backpressure when zeolite loading is increased. For example, typical backpressure limitations for coating a cordierite monolith permit no more than 5 to 6 g/in.³ of slurry (i.e., 3 to 5 g/in.³ zeolite plus 1 to 2 g/in.³ of a three-way catalyst layer). Mixing zeolite and binder materials which are extruded into a monolith allows a higher content of zeolite in the hydrocarbon trap beyond these washcoat limits.

Unless otherwise indicated, the disclosure of any ranges in the specification and claims are to be understood as including the range itself and also anything subsumed therein, as well as endpoints.

Suitable zeolite materials for use in the trap should include microchannel networks (i.e., exhibit a non-cage structure) for intimate and consistent contact between the zeolite framework and adsorbed molecules. The zeolite materials should also have multiple Bronsted acid sites, i.e., a low Si/Al₂ ratio, and the Bronsted acid sites should maintain stability after high temperature aging, e.g., at 700° C. Suitable zeolite materials for use in the trap include beta-zeolites, such as H-beta-40, H-beta-25, ZSM-5 zeolite, or mixtures thereof.

Beta-zeolite materials are preferred for use as they have a larger average pore size of about 5.6 to 7.5 Å in diameter and thus a larger pore volume than other types of zeolites. In addition, beta-zeolites have a pore tunnel structure running through the crystal in all three axis directions, allowing good transport of molecules in and out, and providing consistent zeolite-to-molecule contact. The zeolite preferably has a Si/Al₂ ratio of from about 20 to about 40.

Suitable binder materials for use with the zeolite include alumina, ceria, zirconia, or ceria-zirconia, refractory metals, or mixtures thereof. Other conventional binder materials may also be used.

The zeolite material(s) are mixed with the binder material and water to form a slurry for extrusion through an extrusion die. The zeolite is preferably contained in the slurry at an amount of about 60 to 80% by weight solids, and the binder comprises about 20% to 40% by weight of the slurry. More preferably, the solids content of the slurry contains about 80% by weight zeolite and 20% by weight binder. The three-way catalyst material may also be incorporated in the slurry for extrusion with the zeolite and binder at about 20 to 50% by weight solids. Preferred three-way catalyst metals include platinum, palladium, rhodium, and mixtures thereof.

An oxygen storage capacity (OSC) material may also be included in the slurry in an amount of about 10% by weight solids or less, and more preferably, about 5% by weight solids or less. Suitable OSC materials include ceria-zirconia and ceria-praesodymium. The three-way catalyst and OSC materials may also be incorporated in the slurry with composite binder refractory fibers.

The slurry is extruded through the extrusion die and then allowed to harden to form the monolith structure. The resulting zeolite monolith preferably has an open frontal area (OFA) of between about 40 and 60%. This allows a zeolite load above 5 g/in.³, which allows an additional 2 g/in.³ of the three-way catalyst to be included without exceeding backpressure limits. Preferably, the hydrocarbon trap preferably has a zeolite content of from about 5.0 to about 8.0 g/in.³ The use of a lower open frontal area and thick monolith walls increases diffusional resistance to the desorbing HC molecules at high temperature, which also provides an advantage over washcoated monoliths. The resulting monolith preferably has a cell density of from about 200 cpsi (cells per square inch) to 400 cpsi and a wall thickness of from about 15 mil to 25 mil. It should be appreciated that the relationship between OFA, cell density, and wall thickness is important. For example, increasing the wall thickness of a fixed cpsi will decrease the OFA and increase zeolite content, but will increase backpressure across the monolith, which is undesirable. Similarly, decreasing the cpsi for a monolith having a fixed wall thickness will alleviate backpressure but will decrease mass transfer of inlet HC emissions into the monolith walls, which is undesirable.

In embodiments where the three-way catalyst material is added after extrusion, the catalyst may be applied by washcoating. For example, the three-way catalyst may be coated on the surface of the extruded zeolite monolith substrate by conventional techniques known in the art. Alternatively, the three-way catalyst material may be impregnated into the zeolite monolith by conventional techniques, such as dipping the monolith into a slurry including the catalyst materials which adheres to the walls of the monolith and penetrates into the pores. The OSC materials may also be incorporated by washcoating or impregnation along with the three-way catalyst material.

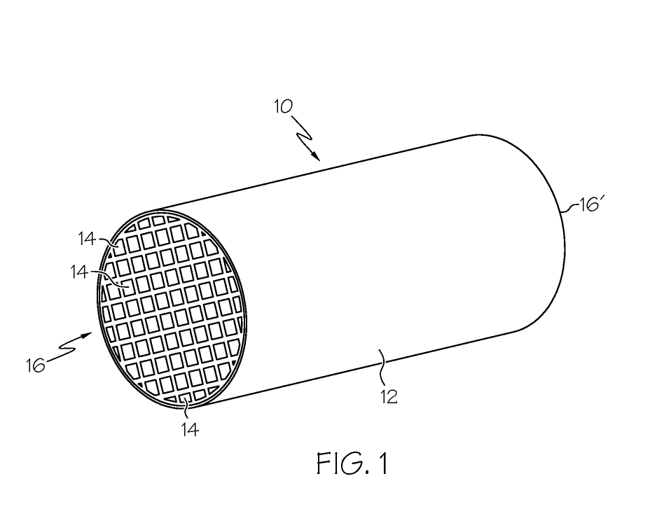

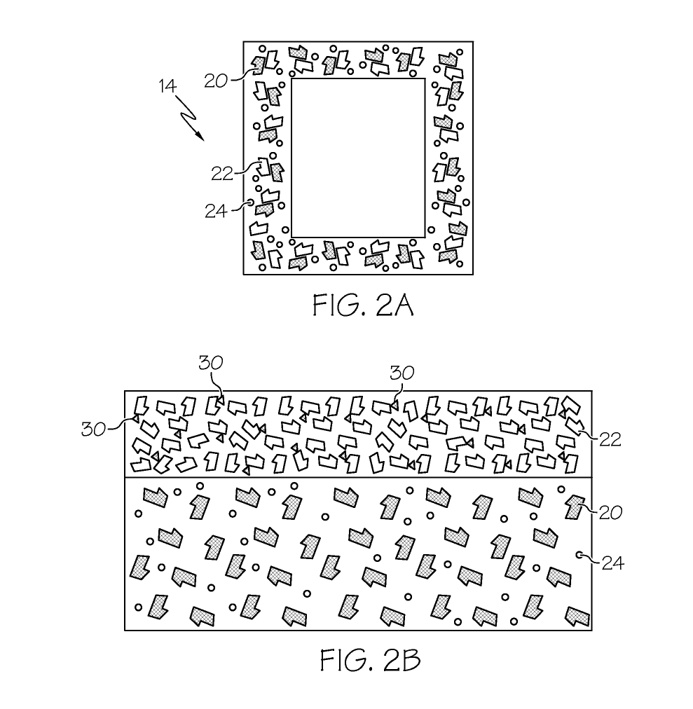

Referring now to FIG. 1, a hydrocarbon trap 10 is illustrated in accordance with an embodiment of the invention. As shown, the trap comprising the extruded zeolite monolith includes an outer surface 12 and a plurality of generally parallel gas flow channels or cells 14 extending from the inlet face 16 through outlet face 16′. An enlarged view of a single cell 14 of the extruded monolith structure is illustrated in FIGS. 2A and 2B. The structure shown in FIG. 2A includes the hardened/extruded zeolite material 20, a three-way catalyst material 22, and binder material 24. An OSC material (not shown) may also be present in the extruded zeolite monolith in contact with the three-way catalyst. While square cells are illustrated, it is within the scope of the invention to have hexagonally-shaped cells or other geometric shapes.

FIG. 2B illustrates an alternative embodiment in which the extruded zeolite monolith structure has been washcoated with a layer of the three-way catalyst material 22 and an OSC material 30 which is in contact with the three-way catalyst as shown.

It should be appreciated that the three-way catalyst may be present either in the extruded zeolite or as a washcoat, but it is not necessary to be present both within the monolith and as a surface washcoat.

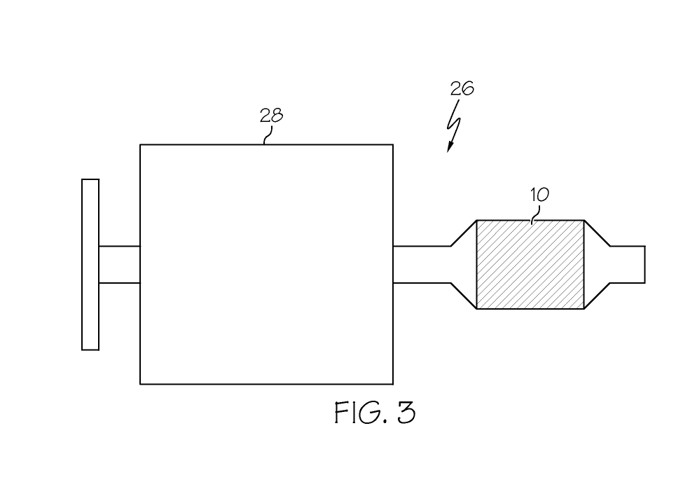

Referring now to FIG. 3, an exhaust treatment system 26 including the hydrocarbon trap 10 is shown. As shown, the exhaust treatment system is coupled to an exhaust manifold 28 of an engine (not shown). The system may include additional catalysts or filters (not shown) in addition to the hydrocarbon trap.

During operation, as exhaust gas generated by the engine passes through the hydrocarbon trap 10, the cold-start emissions of ethanol and hydrocarbons such as propylene and toluene are adsorbed and stored in the trap. Absorbed ethanol and hydrocarbons will not be released until the engine and the exhaust therefrom reach sufficiently elevated temperatures to cause desorption. Preferably, substantial desorption of the trapped emissions is delayed until the catalyst reaches its light-off temperature. The desorbed molecules are then oxidized to CO₂ and H₂O by the three-way catalyst. In embodiments where the trap includes an OSC material, the material supplies oxygen for the catalyzed oxidation reaction.

In order that the invention may be more readily understood, reference is made to the following examples, which are intended to illustrate the invention, but are not to be taken as limiting the scope thereof.

### EXAMPLE 1

Hydrocarbon traps comprising extruded zeolite monoliths prepared in accordance with embodiments of the invention were compared with traps comprising washcoated zeolite monoliths on cordierite with regard to hydrocarbon retention. The extruded zeolites comprised 80 wt % H-BEA-40 zeolite and 20 wt % binder. The washcoated zeolite monoliths contained about 95% zeolite and 5% binder (alumina/zirconia) and had a nominal washcoat loading of 3 g/in.³ or 4 g/in³ on a 400 cpsi/4.5 mil cordierite monolith.

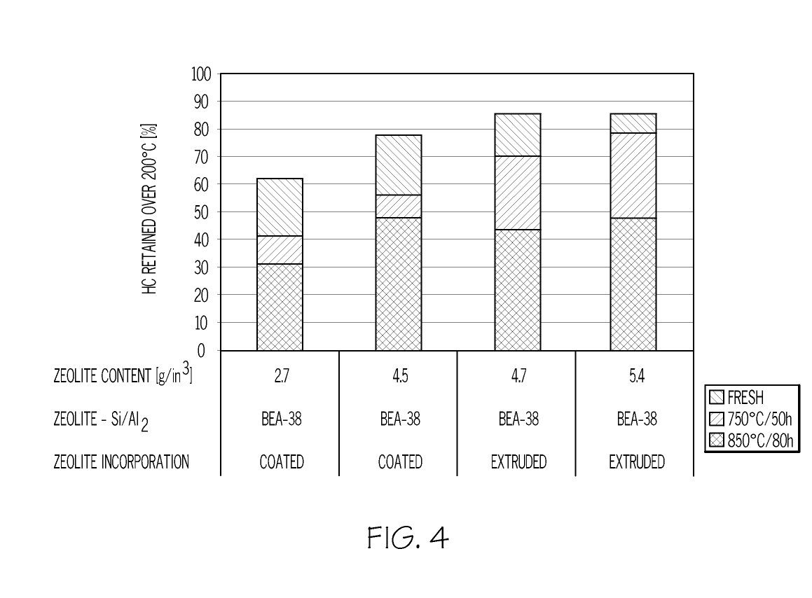

All of the monoliths utilized beta-zeolite with equal Si/Al₂ ratios (38). All of the monoliths were evaluated at three different age levels; i.e., fresh, 700° C./50 h, and 850° C./80 h. As can be seen in FIG. 4, the amount of stored hydrocarbons retained at temperatures above 200° C. increased with increasingamounts of zeolite in the traps. Also, as can be seen, the extruded zeolite monoliths had the highest zeolite loading, i.e., 4.7 g/in³ and 5.4 g/in³, respectively.

### EXAMPLE 2

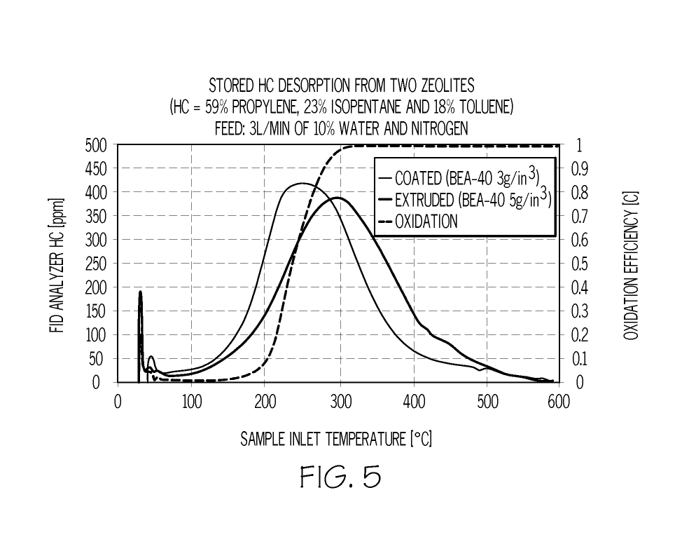

An extruded zeolite monolith comprising 80 wt % H-BEA-40 zeolite and 20 wt % binder was prepared in accordance with an embodiment of the invention and tested for HC desorption at different temperatures. A washcoated zeolite monolith (on cordierite) was also prepared as in Example 1. FIG. 5 illustrates the stored hydrocarbon desorption from the two traps as well as the oxidation efficiency. The catalyst used to generate the oxidation curve in FIG. 5 was 80 g/ft³ platinum metal, which was impregnated into the extruded zeolite sample, and was evaluated separately from the two uncatalyzed zeolite samples used to generate the released HC curves shown in FIG. 5. A synthetic blend of three representative HC species (59% propylene, 23% isopentane, and 18% toluene) was used to simulate gasoline emissions. As can be seen, the extruded zeolite monolith achieves greater oxidation efficiency as more stored HC desorbs above the temperature of the oxidation line than the washcoated sample. In addition, the extruded monolith delayed HC desorption until temperatures ranging from about 200 to 400° C. were reached, while the coated monolith desorbed HC at lower temperatures.

### EXAMPLE 3

The following samples were prepared for testing adsorbed (stored) HC oxidation performance:

Sample 1 comprised a washcoated zeolite on a cordierite monolith with a TWC washcoat overlayer containing a catalyst material at a loading of 135 g/ft³ and about 5 wt % of an OSC material.

Sample 2 comprised an extruded zeolite with impregnated platinum at a loading of 82 g/ft³.

Sample 3 comprised an extruded zeolite with impregnated platinum at a loading of 84 g/ft³ and 600 g/ft³ of OSC material comprising ceria-praesodymium (50/50 mix).

Sample 4 comprised an extruded zeolite with impregnated platinum at a loading of 82 g/ft³ and 1200 g/ft³ of OSC material (comprising ceria-praesodymium (50/50 mix).

Sample 5 comprised an extruded zeolite with a TWC catalyst washcoat overlayer containing a catalyst material at a loading of 100 g/ft³ and an OSC material (PrCe) at greater than about 5 wt %.

The testing conditions included preconditioning of the samples at 650° C. in 2% oxygen and nitrogen, then a 5-minute reduction in 0.2% CO, 0.08% H₂ in nitrogen, followed by a cooldown to 30° C. in nitrogen. In orcbr to simulate gasoline cold start emissions, each sample was exposed to a loading of 0.15% HC species (59% propylene, 23% isopentane, and 18% toluene), 0.2% CO, 0.8% H₂, and 10% water vapor in air at 30,000/hr and 30° C. for 30 seconds. After 30 seconds, the HC was removed from the feed stream and the carrier gas was switched from oxygen to nitrogen.

The following conditions were used:

Inert TPD (temperature programmed desorption) (lambda=1.000) 10% water vapor in nitrogen

Stoichiometric TPD (lambda=1.007) 500 ppm CO, 188 ppm H₂, 700 ppm O₂, 10% water vapor in nitrogen

Lean TPD (lambda=1.12) 500 ppm CO, 188 ppm H₂, 2% O₂, 10% water vapor in nitrogen

The feed was reintroduced to the samples and the sample oven was triggered to ramp from 30° C. to 600° C. at 100° C./min. The adsorbed HC converted is the amount of stored HC not detected by the FID analyzer to desorb from the sample by 600° C. since the FID analyzer does not detect CO or CO₂ (integrated HC desorption area/integrated adsorption area).

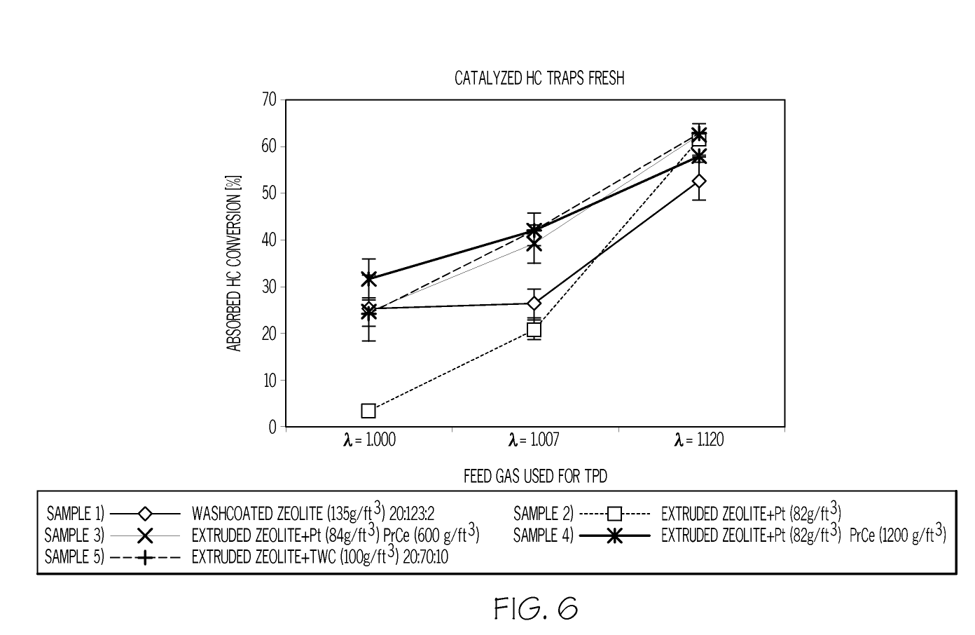

Referring now to FIG. 6, it can be seen that the oxidation performance of Sample 2 suffered when the gas-phase oxygen was scarce (lambda=1.007) or absent (lambda=1.000). In addition, it can be seen that extruded zeolites provide better HC retention in comparison with washcoated zeolites. Adding an OSC material to the catalyst in the extruded substrate (samples 3-5) provides good HC oxidation performance.

### EXAMPLE 4

Extruded zeolite monoliths comprising 80 wt % H-BEA-40 zeolite and 20 wt % binder were prepared in accordance with an embodiment of the invention with varying OFA's and were tested for HC adsorption and desorption. The results are shown in Table 1 below.

TABLE 1
10% H₂0 in N₂, λ = 1.00

| | HC Adsorbed | Adsorbed | HC Desorbed | HC Desorbed | Adsorbed HC |
|---|---|---|---|---|---|
| | HC (%) (%) | Desorbed | 50% (° C.) | 80% (° C.) | At 200° C. (%) |
| OFA = 61.5% | | | | | |
| H-BEA-40 | 78.0 +/− 0.9 | 106 +/− 1 | 257 +/− 7 | 365 +/− 10 | 64 +/− 2 |
| 81 cpsi/24 mil | | | | | |
| OFA = 57.4% | | | | | |
| H-BEA-40- | 86.5 +/− 2.3 | 93 +/− 5 | 229 +/− 2 | 337 +/− 9 | 61 +/− 3 |
| 300 cpsi/14 mil | | | | | |
| OFA = 54.8% | | | | | |
| H-BEA-40 | 92.4 +/− 2.0 | 104 +/− 2 | 268 +/− 3 | 360 +/− 10 | 75 +/− 2 |
| 300 cpsi/15 mil | | | | | |
| OFA = 51.8% | | | | | |
| H-BEA-40 | 92.5 +/− 2.9 | 105 +/− 3 | 294 +/− 7 | 378 +/− 9 | 78 +/− 2 |
| 400 cpsi/14 mil | | | | | |

As can be seen, the monolith with the lowest OFA (51.8%) exhibited better performance for HC adsorption, HC desorption, as well as the amount of adsorbed HC at a bed temperature of 200° C. The zeolite with a wall thickness of 81 cpsi/24 mil had the thickest walls, but was the worst performing sample due to the large monolith cell size (81 cpsi) which caused inlet HC mass transfer limitations into the monolith walls during the adsorption pulse. It is noted that the 300 cpsi/14 mil monolith was outperformed by the 300 cpsi/15 mil monolith in each instance. In addition, it can be seen that the 400 cpsi/14 mil monolith (lowest OFA of 51.8%) exhibited superior performance over the 300 cpsi/14 mil monolith (OFA 54.8%) with regard to HC adorption and retention.

Having described the invention in detail and by reference to preferred embodiments thereof, it will be apparent that modifications and variations are possible without departing from the scope of the invention.

What is claimed is:

1. A hydrocarbon trap for reducing cold-start vehicle exhaust emissions comprising:
a monolithic substrate formed from an extruded hydrocarbon trapping material comprising from about 60 to 80% by weight zeolite and from about 20 to 40% by weight of a binder; and a three way catalyst.

2. The hydrocarbon trap of claim 1 wherein said zeolite has a Si/Al₂ ratio of from about 20 to about 40.

3. The hydrocarbon trap of claim 1 wherein said zeolite is selected from beta-zeolite, ZSM-5 zeolite, or mixtures thereof.

4. The hydrocarbon trap of claim 1 wherein said zeolite has an average pore size of about 4 to about 8 Å.

5. The hydrocarbon trap of claim 1 wherein said binder is selected from alumina, ceria, zirconia, or ceria-zirconia, refractory metals, or mixtures thereof.

6. The hydrocarbon trap of claim 1 wherein said three-way catalyst comprises a precious metal selected from platinum, palladium, rhodium, and mixtures thereof.

7. The hydrocarbon trap of claim 1 wherein said monolithic substrate has a wall thickness of about 10 to 20 mils.

8. The hydrocarbon trap of claim 1 wherein said monolithic substrate has a cell density of about 200 to 400 cells/in.² (cpsi).

9. The hydrocarbon trap of claim 1 having a zeolite content of about 5.0 to 8.0 g/in³.

10. The hydrocarbon trap of claim 1 including an oxygen storage capacity material.

11. The hydrocarbon trap of claim 10 wherein said oxygen storage capacity material is selected from ceria-zirconia, cera-praesodymium, or mixtures thereof.

12. A hydrocarbon trap for reducing cold-start vehicle exhaust emissions comprising:
a monolithic substrate formed from an extruded hydrocarbon trapping material comprising from about 60 to 80% by weight zeolite and from about 20 to 40% by weight of a binder; and a three way catalyst; wherein said substrate has a wall thickness of about 10 to 20 mils and a cell density of about 200 to 400 cells/int.

13. A method of forming a hydrocarbon trap for use in an exhaust treatment system comprising:
providing a slurry of a hydrocarbon trapping material comprising from about 60 to 80% by weight zeolite, from about 20 to 40% by weight of a binder, a three-way catalyst, and optionally, an oxygen storage capacity material; and
extruding said slurry through an extrusion die to form a monolithic substrate.

14. The method of claim 13 wherein said three-way catalyst comprises a precious metal selected from platinum, palladium, rhodium, and mixtures thereof.

15. The method of claim 13 wherein said oxygen storage capacity material comprises ceria-zirconia, ceria-praesodymium, or mixtures thereof.

16. The method of claim 13 wherein said monolithic substrate has an open frontal area (OFA) of about 40 to 60%.

17. A method of forming a hydrocarbon trap for use in an exhaust treatment system comprising:
providing a slurry of a hydrocarbon trapping material comprising from about 60 to 80% by weight zeolite and from about 20 to 40% by weight of a binder;
extruding said slurry through an extrusion die to form a monolithic substrate; and
coating a three-way catalyst on said extruded monolithic substrate.

18. A method of forming a hydrocarbon trap for use in an exhaust treatment system comprising:
providing a slurry of a hydrocarbon trapping material comprising from about 60 to 80% by weight zeolite and from about 20 to 40% by weight of a binder;
extruding said slurry through an extrusion die to form a monolithic substrate; and
impregnating a three-way catalyst in said extruded monolithic substrate.

19. An exhaust treatment system comprising the hydrocarbon trap of claim 1 positioned in an exhaust passage of a vehicle.

20. A method for reducing cold start hydrocarbon emissions from a vehicle engine comprising:
providing a hydrocarbon trap positioned in an exhaust passage of a vehicle, said hydrocarbon trap comprising a monolithic substrate formed from an extruded hydrocarbon trapping material comprising from about 60 to 80% by weight zeolite, from about 20 to 40% by weight of a binder; and a three-way catalyst; and
passing exhaust gases through said trap at a gas space velocity of about 30,000/hr; wherein said trap adsorbs from about 50 to 90% hydrocarbons at a temperature between about −40 and 200° C.
